(19) United States
(12) Patent Application Publication
(10) Pub. No.: US 2022/0011760 A1
(43) Pub. Date: Jan. 13, 2022

(54) MODEL FIDELITY MONITORING AND REGENERATION FOR MANUFACTURING PROCESS DECISION SUPPORT

(71) Applicant: International Business Machines Corporation, Armonk, NY (US)

(72) Inventors: Nianjun Zhou, Chappaqua, NY (US); Dharmashankar Subramanian, White Plains, NY (US); Dhavalkumar C. Patel, White Plains, NY (US); Anuradha Bhamidipaty, Yorktown Heights, NY (US)

(21) Appl. No.: 16/923,148

(22) Filed: Jul. 8, 2020

(51) Int. Cl. G05B 23/02; G05B 13/04; G05B 13/02

(52) U.S. Cl. CPC G05B 23/024; G05B 13/0265; G05B 13/04

(57) ABSTRACT

Techniques for model fidelity monitoring and regeneration for manufacturing process decision support are described herein. Aspects of the invention include determining that an output of a regression model corresponding to a current time period of decision support for a manufacturing process is not within a predefined range of a historical process dataset, wherein the regression model was constructed based on the historical process dataset, and performing an accuracy and fidelity analysis on the regression model based on process data from the manufacturing process corresponding to a previous time period. Based on a result of the accuracy and fidelity analysis being below a threshold, a mismatch of the regression model as compared to the manufacturing process is determined. Based on determining the mismatch, a temporary regression model corresponding to the manufacturing process is generated, and decision support for the manufacturing process is performed based on the temporary regression model.

### BACKGROUND

The present invention generally relates to programmable computers, and more specifically, to programmable computers configured and arranged to perform machine learning based model fidelity monitoring and regeneration for models used for manufacturing process decision support.

Many fields incorporate machine learning models to perform tasks that involve analysis of data, and that further involve using the results of that analysis as the basis of future actions. In general, machine learning models, such as regression or classification, are generated by and run on various mathematical representations, neural networks, which can be implemented as programmable computers configured to run a set of machine learning algorithms. Machine learning, including neutral networks, incorporate knowledge from a variety of disciplines, including neurophysiology, cognitive science/psychology, physics (statistical mechanics), control theory, computer science, artificial intelligence, statistics/mathematics, pattern recognition, computer vision, parallel processing and hardware (e.g., digital/analog/VLSI/optical).

The basic function of machine learning algorithms including neural networks is to recognize patterns by interpreting sensory data through a kind of machine perception. Unstructured real-world data in its native form (e.g., images, sound, text, or time series data) is converted to a numerical form (e.g., a vector having magnitude and direction) that can be understood and manipulated by a computer. The machine learning algorithm performs multiple iterations of learning-based analysis on the real-world data vectors until patterns (or relationships) contained in the real-world data vectors are uncovered and learned. The learned patterns/relationships function as predictive models that can be used to perform a variety of tasks, including, for example, classification (or labeling) of real-world data and clustering of real-world data.

Machine learning can be used to construct and train one or more models corresponding to a process (e.g., a manufacturing process). In general, such models can be trained using supervised or unsupervised learning to represent the response of the manufacturing process to raw materials, other intermediate product inflows, and the similarity of the process episodes based on the states of the inflows and outflows. In a supervised learning model, the machine learning algorithm learns on a labeled dataset, and an answer key that the algorithm can use to evaluate its accuracy on training data. An unsupervised model, in contrast, is trained by providing unlabeled data that the machine learning algorithm tries to make sense of by extracting features and patterns on its own. For example, the previously-described manufacturing process models can be developed and trained using sensor data gathered from sensors that are located throughout the manufacturing process, for example, in one or more plants that implement the manufacturing process. The trained models can be used to simulate and monitor the manufacturing process during operation. The manufacturing process can include multiple stages, or process steps, that receive process inputs, perform a series of operations using the inputs, and output one or more process outputs. Each stage in the manufacturing process can receive an output of a previous stage, and can also receive additional process inputs.

In the fields of scientific modelling and simulation, fidelity refers to the degree to which a machine learning model or simulation reproduces the state and behavior of a real-world manufacturing process, feature, or condition. In this context, fidelity is therefore a measure of the realism of the supervised regression models used to support the optimization or decision process.

### SUMMARY

Embodiments of the present invention are directed to with model fidelity monitoring and regeneration for manufacturing process decision support. A non-limiting example computer-implemented method includes determining that an output of a regression model corresponding to a current time period of decision support for a manufacturing process is not within a predefined range of a historical process dataset from the manufacturing process, wherein the regression model was constructed based on the historical process dataset. Based on determining that the output of the regression model corresponding to the current time period of decision support for the manufacturing process is not within the predefined range of the historical process dataset, an accuracy and fidelity analysis is performed on the regression model based on process data from the manufacturing process corresponding to a previous time period. Based on a result of the accuracy and fidelity analysis being below a threshold, a mismatch of the regression model as compared to the manufacturing process is determined. Based on determining the mismatch, a temporary regression model corresponding to the manufacturing process is generated, and decision support for the manufacturing process is performed based on the temporary regression model.

A non-limiting system includes a memory having computer readable instructions and one or more processors for executing the computer readable instructions, the computer readable instructions controlling the one or more processors to perform operations including determining that an output of a regression model corresponding to a current time period of decision support for a manufacturing process is not within a predefined range of a historical process dataset from the manufacturing process, wherein the regression model was constructed based on the historical process dataset. Based on determining that the output of the regression model corresponding to the current time period of decision support for the manufacturing process is not within the predefined range of the historical process dataset, an accuracy and fidelity analysis is performed on the regression model based on process data from the manufacturing process corresponding to a previous time period. Based on a result of the accuracy and fidelity analysis being below a threshold, a mismatch of the regression model as compared to the manufacturing process is determined. Based on determining the mismatch, a temporary regression model corresponding to the manufacturing process is generated, and decision support for the manufacturing process is performed based on the temporary regression model.

A non-limiting computer program product includes a computer readable storage medium having program instructions embodied therewith, the program instructions executable by one or more processors to cause the one or more processors to perform operations including determining that an output of a regression model corresponding to a current time period of decision support for a manufacturing process is not within a predefined range of a historical process dataset from the manufacturing process, wherein the regression model was constructed based on the historical process dataset. Based on determining that the output of the regression model corresponding to the current time period of decision support for the manufacturing process is not within the predefined range of the historical process dataset, an accuracy and fidelity analysis is performed on the regression model based on process data from the manufacturing process corresponding to a previous time period. Based on a result of the accuracy and fidelity analysis being below a threshold, a mismatch of the regression model as compared to the manufacturing process is determined. Based on determining the mismatch, a temporary regression model corresponding to the manufacturing process is generated, and decision support for the manufacturing process is performed based on the temporary regression model.

Another non-limiting example computer-implemented method includes identifying a neighborhood of a current output of a process step regression model, the process step regression model corresponding to a single stage of a manufacturing process. Based on identifying the neighborhood, opportunity modeling of the single stage of the manufacturing process is performed based on the process step regression model. Based on being unable to identify the neighborhood, the process step regression model is regenerated.

Another non-limiting system includes a memory having computer readable instructions and one or more processors for executing the computer readable instructions, the computer readable instructions controlling the one or more processors to perform operations including identifying a neighborhood of a current output of a process step regression model, the process step regression model corresponding to a single stage of a manufacturing process. Based on identifying the neighborhood, opportunity modeling of the single stage of the manufacturing process is performed based on the process step regression model. Based on being unable to identify the neighborhood, the process step regression model is regenerated.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 is a block diagram of components of a manufacturing process modeling system for use in conjunction with model fidelity monitoring and regeneration for manufacturing process decision support in accordance with one or more embodiments of the present invention;

FIG. 2 is a block diagram of components of a system for model fidelity monitoring and regeneration for manufacturing process decision support in accordance with one or more embodiments of the present invention;

FIG. 3 is a block diagram of components of a system for model fidelity monitoring and regeneration for manufacturing process decision support in accordance with one or more embodiments of the present invention;

FIG. 4 is a block diagram of components of a system for regression model analysis for use in conjunction with model fidelity monitoring and regeneration for manufacturing process decision support in accordance with one or more embodiments of the present invention;

FIG. 5 is a block diagram of components of a system for model retraining for use in conjunction with model fidelity monitoring and regeneration for manufacturing process decision support in accordance with one or more embodiments of the present invention;

FIG. 6 is a flow diagram of a process for model fidelity monitoring and regeneration for manufacturing process decision support for an overall manufacturing process utilizing a regression model in accordance with one or more embodiments of the present invention;

FIG. 7 is a flow diagram of another process for model fidelity monitoring and regeneration for manufacturing process decision support for a process step regression model in accordance with one or more embodiments of the present invention; and

FIG. 8 is a block diagram of an example computer system for use in conjunction with one or more embodiments of model fidelity monitoring and regeneration for manufacturing process decision support.

### DETAILED DESCRIPTION

One or more embodiments of the present invention provide programmable computers that execute a novel model fidelity monitoring and regeneration for manufacturing process optimization and decision support, configured and arranged to measure of the accuracy with which a model reproduces the real state and/or behavior of the manufacturing process at the optimization time. Real-time production optimization in response to changing plant and market conditions is performed in manufacturing settings, in which instrumented plants accumulate vast amounts of sensor data over time. Data-driven approaches for real-time optimization involve a prediction-optimization pattern, where regression models are generated based on the sensor data to capture relevant input-output predictive relationships. The regression models are used within optimization models that compute set points for control variables over a lookahead time horizon to support the decision support that optimizes production-related key performance indices in the manufacturing process. However, usage of the optimization models can lead to inconsistencies, including systematic error between models and current real world conditions, a mismatch between projected and actual response, and sensitivity of values used for non-control variables. Therefore, model fidelity monitoring can be applied to the regression models that are used for decision support in the manufacturing process, and alerts can be generated to correct the regression models based on the model fidelity monitoring.

Embodiments of the invention utilize a trained regression model to monitor and simulate a manufacturing process in the field, in order to provide real-time decision support during operation of the manufacturing process. Decision support relies on the accuracy of harvested sensor data, and the fidelity to the manufacturing process response from the optimization of the regression models that are developed from the sensor data. The sensor data can include any of, but is not limited to, temperature, level, flow rate, weight, actuator, and volume data. Through the lifespan of a manufacturing process, operating conditions can change, and model deterioration and misalignment can occur over time due to shifting of process operations (e.g., operational changes, model usage changes, and/or equipment deterioration in a plant). Embodiments of the invention accommodate changes that occur in a manufacturing process over time by monitoring the fidelity of the models corresponding to the manufacturing process and performing a regeneration of the models if the models are determined to have deteriorated to the point that the models are an inaccurate representation of the operating in the manufacturing process, such that the models cannot be relied upon for decision support. Accordingly, embodiments of the invention ensure that the models that are used for manufacturing process decision support reflect the actual conditions in the manufacturing process relatively accurately.

In order to generate regression models for use in real-time decision support, choices are made regarding how the regression models should be built and how the corresponding optimization models should be formulated. However, it may not be clear what criteria should be used for feature selection or model selection for regression models for embedding within an optimization model to determine control setpoints over a future time horizon. Further, it may not be clear what is an appropriate length of the lookahead time horizon for the optimization model, or how to treat control variables differently from non-control variables (e.g., variables that may not be controlled by the decision maker) in the regression modeling and the optimization. These various choices may lead to inconsistencies between assumptions made in regression model building and the subsequent use of the regression models in process optimization.

Based on a determination that an output of the regression model corresponding to a current time period for decision support is not within a predefined range of a historical process dataset from the manufacturing process, an accuracy and fidelity analysis can be performed on the regression model based on process data from a previous time period. Based on a result of the accuracy and fidelity analysis being below a threshold, a mismatch between a real-world manufacturing process with respect to the one or model regression models that were constructed based on the historical process dataset can be detected by embodiments of the present invention. It can be determined that the regression model is not accurate, and a temporary regression model can be generated to replace the inaccurate regression model. Generation of the temporary regression model can trigger a remediation process that is performed with modified or updated regression models, and an updated lookahead time horizon can be determined for decision support for the manufacturing process using the modified or updated regression models.

Embodiments of the invention utilize regression models to reflect statistical relationships between variables in the manufacturing process. In aspects of the invention, the regression models can be built by defining relationships between inputs and outputs for each step of the manufacturing process. In embodiments of the invention, model fidelity monitoring can be performed for a regression model corresponding to a single process step, or for multiple regression models corresponding to the larger or overall manufacturing process. In some embodiments of the present invention, model deterioration can be detected based on model decision outputs not being aligned with real process outcomes. In some embodiments of the present invention, model deterioration can be detected based on detected changes in statistical distributions of model outputs, or based on a determination that a process state is a mismatch or out of scope in the compressed embedded space. In embodiments of the invention, the model fidelity monitoring for regression models can be performed based on autoencoder models that capture the manufacturing process status with lower dimensional representation.

Embodiments of the present invention include model fidelity monitoring for global, or process-wide, regression modeling, which can provide decision support using optimization across the manufacturing process with a relatively long time lookahead window (e.g., 12 hours up to 2 weeks). In aspects of the invention, the global regression models can be constructed based on supervised machine learning to connect the inflows and outflows of each physical and/or chemical transformation in the manufacturing process with a longer time period of historical data (e.g., several years of data). In some aspects of the invention, to reflect the overall manufacturing process, the static, more comprehensive regression models can be constructed based on time-series data from a relatively large number of sensors (e.g., 100-200 sensors) located throughout the manufacturing process, and can output target objective values for any appropriate process outputs, including but not limited to monetary, output product, raw material, and additive usage objectives.

Embodiments of the present invention include model fidelity monitoring for single process step decision support using a neighborhood concept. Single process step regression models can provide decision support for a relatively short time horizon (e.g., 2-3 hours). A single process step model can determine a single objective for a physical or chemical transformation that is performed in the process step. The single process step model can be generated using unsupervised machine learning based on time-series data from a relatively small number of sensors (e.g., 10-20 sensors) located within the process step, and decision support can be provided by identification of similar historical episodes as compared to a current scenario by the model. The single process step model can be built based on an embedded neighborhood space. A single product quantity or quality can be output as the target objective of the single process step model.

In some embodiments of the present invention, model deterioration can result from limited sensor data sampling or limitation of the model function type at the time of model construction and training. For example, the selection of initial values for non-decision variables as constants in the model can result in drifting of the regression relationship. Therefore, the results of an optimization solution performed using the regression model can be less reliable over a relatively long decision support time (e.g., 24 or 48 hours). In embodiments of the invention, any assumptions that were used in the creation of the model can be identified, and how the assumptions affect the continuing operation of the model can be determined. These include using temporary or ad-hoc regression models that agree with the current plant state, such as plant operating-mode or operating-neighborhood based modeling practices, as well as the use of statistical hypothesis testing to limit the length of the lookahead time horizon for decision support. In embodiments of the invention where a regression model creation process is implemented in conjunction with model fidelity monitoring and regeneration, for a dependent variable, a set of independent, including control as well as non-control variables, variables are chosen to produce a regression model. A process dataset can be determined by measuring sensor data corresponding to the dependent variable and independent variables (including control and non-control variables) at any appropriate interval during operation of the manufacturing process (e.g., hourly). A set of process data from one or multiple continuous time periods is used to create the training data for regression model generation. A static regression model can be generated using process data from a relatively long time period (e.g., 2-3 years) before an optimization scenario time. In some embodiments of model fidelity monitoring and regeneration, based on detection of model deterioration in the static regression model, a temporary dynamic regression model can be generated using process data from time periods just before an optimization scenario time as a replacement for the static regression model.

In embodiments of the invention, real-time model fidelity monitoring for a manufacturing process is performed for a given time period, based on process-wide optimization. A sensor dataset including the plant-wide variables that were used to generate the regression models is identified to link the process steps, and the time series representation of the sensor dataset is extracted with autoencoder and neighborhood embedding. Any historical scenarios that apply to current plant-wide operation can be checked, and the decision support or optimization can be aborted if the check of the historical scenarios fails. The accuracy of the regression model can be checked with data from nearby time periods, and a temporary dynamic regression model can be generated if the accuracy detection fails. The impact of non-control variables on the reliability of the regression model can be determined, and an appropriate lookahead time horizon for decision support by the regression model can be determined based on the impact analysis of non-control variables. For a single process step model, a time series representation of data for the process step can be extracted with autoencoder and neighborhood embedding, and a neighborhood of the current state can be identified. The single process step model can be regenerated if the neighborhood cannot be identified properly.

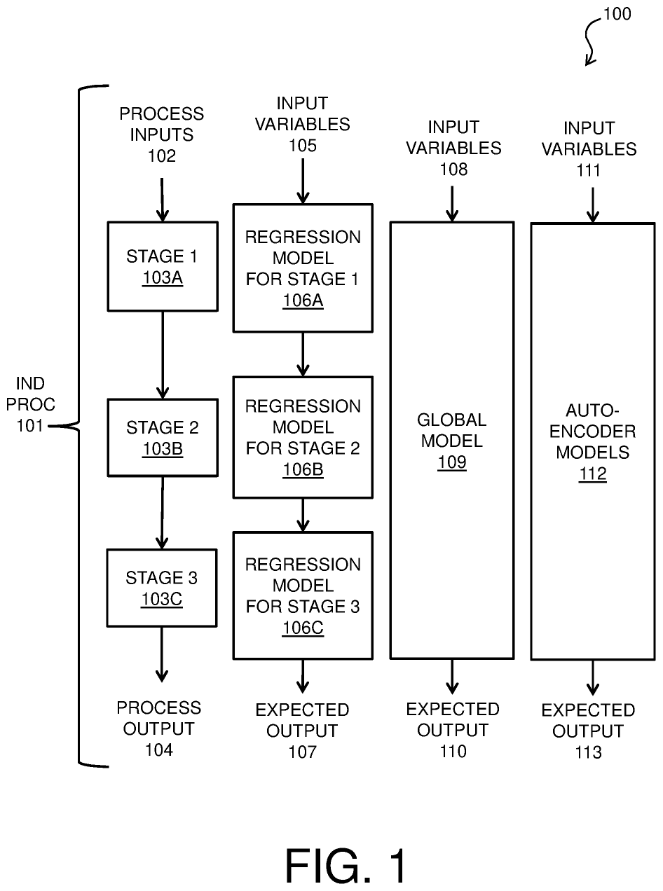

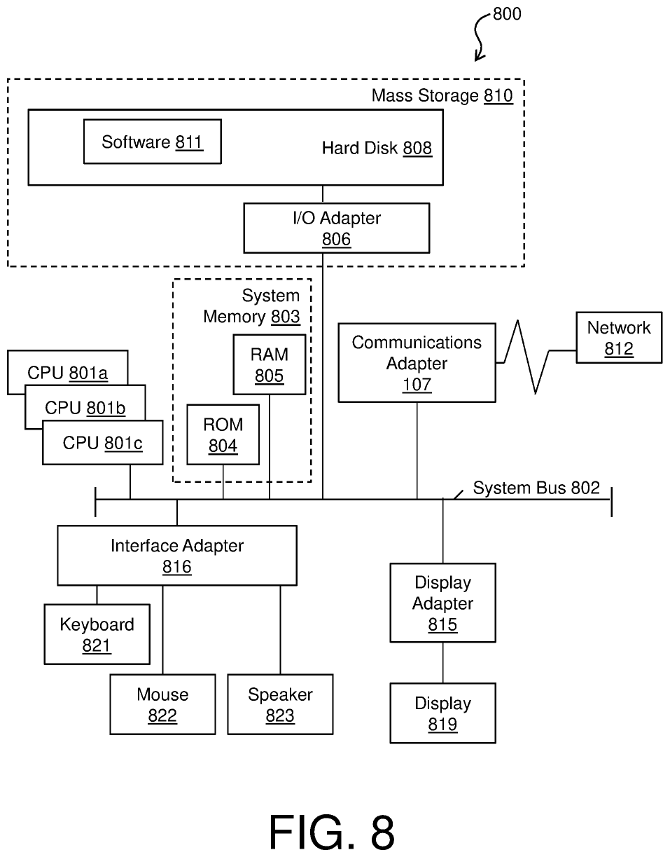

Turning now to FIG. 1, a manufacturing process modeling system 100 for use in conjunction with model fidelity monitoring and regeneration for manufacturing process decision support is generally shown in accordance with one or more embodiments of the present invention. Embodiments of system 100 can be implemented in conjunction with any appropriate computer system, such as computer system 800 of FIG. 8. Manufacturing process modeling system 100 includes a multi-stage manufacturing process 101, including stages 103A-C. Manufacturing process 101 can include any appropriate manufacturing process, including but not limited to a manufacturing process. Manufacturing process 101 can include operations that are performed across any appropriate number of plants. Manufacturing process 101 receives process inputs 102, and outputs process outputs 104 through stages 103A-C. Process inputs 102 and process output 104 can include any appropriate materials that can be used in or produced by a manufacturing process, and can be quantified by any appropriate number of sensors of any appropriate type that are located throughout stages 103A-C in the manufacturing process 101. Any of stages 103A-C can receive any appropriate additional process inputs in various embodiments of the present invention. For each of stages 103A-C, a respective regression model 106A-C is constructed. Regression models 106A-C receive input variables corresponding to process inputs 102 and output expected output 107, which correspond to process outputs 104. A global regression model 109 corresponding to the entire manufacturing process 101 can be constructed; the global regression model 109 receives input variables corresponding to process inputs 102 and outputs expected output 110 corresponding to process output 104. In some embodiments of the invention, global regression model 109 can include a set of regression models. Autoencoder models 112 can be constructed corresponding to manufacturing process 101; in various embodiments of the invention, autoencoder models can include multiple manufacturing process steps and/or single manufacturing process step of plant sensor data. Autoencoder models 112 receive input variables 111 which correspond to process inputs 102 and output expected output 113 corresponding to process output 104. Autoencoder models 112 capture the status of the manufacturing process 101 with lower dimensional representation as compared to the single step or multiple steps of manufacturing processing status. Each of the sensor datasets that make up input variables 105, input variables 108, and input variables 111 can include the same or different sensor data in various embodiments of the present invention.

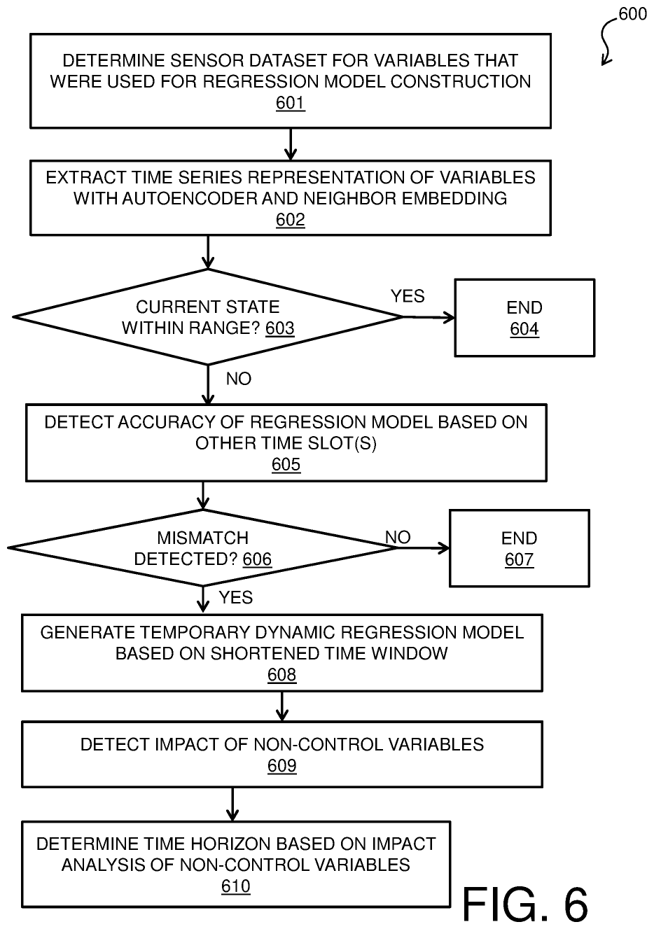

For an example embodiment of a manufacturing process modeling system 100, in which (x₁, x₂, . . . , xₙ₋₁, xₙ) are input variables 108 corresponding to process inputs 102, \tilde{y} is an expected output 110 from global regression model 109, and y is the true value of the outcome from the manufacturing process (corresponding to process output 104), the regression model of the manufacturing process corresponding to model 109 can be represented as \tilde{y}=f(x₁, x₂, . . . , xₙ₋₁, xₙ). The fidelity of the model 109 can be analyzed based on observed differences between y and \tilde{y}. An optimization model solution can generate partial variables of the independent variables of the manufacturing process over a time period [t₁, t₂, . . . , tₘ] (e.g., independent variables (x₁, x₂, . . . , xₖ)ₜ where k≤n). The generated variables are control variables of an optimization problem corresponding to the model 109 for the time period of [t₁, t₂, . . . , tₘ] with indices [1, 2, . . . , m] in which m is the time horizon. The remaining variables (i.e., non-control variables) can be initialized in the model 109 with respective values corresponding to t₀, (e.g., before the time period [t₁, t₂, . . . , tₘ]). The model 109 can use periodic sensor data from manufacturing process 101 for the control variables to determine input and output relationships; however, model deterioration can result from using t₀ values for the non-control variables. Determination of model deterioration based on identification of non-control variables is discussed in further detail below with respect to method 600 of FIG. 6.

It is to be understood that the block diagram of FIG. 1 is not intended to indicate that the system 100 is to include all of the components shown in FIG. 1. Rather, the system 100 can include any appropriate fewer or additional components not illustrated in FIG. 1 (e.g., additional stages, models, process inputs, process outputs, input variables, expected outputs, memory components, embedded controllers, functional blocks, connections between functional blocks, modules, inputs, outputs, etc.). Further, the embodiments described herein with respect to system 100 can be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

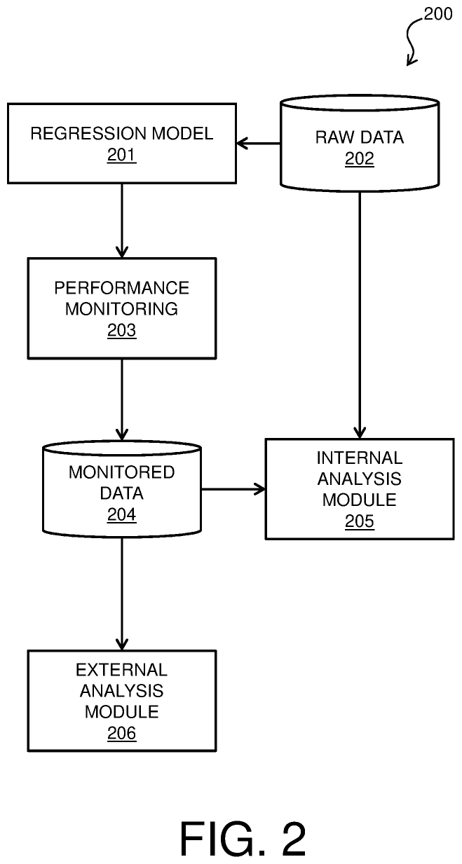

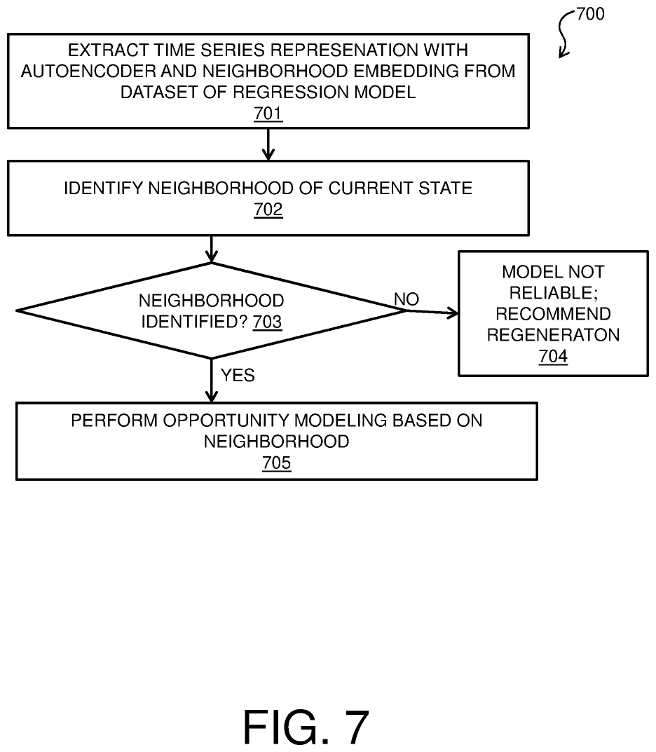

FIG. 2 shows a system 200 for model fidelity monitoring and regeneration for manufacturing process decision support in accordance with one or more embodiments of the present invention. Embodiments of system 200 can be implemented in conjunction with any appropriate computer system, such as computer system 800 of FIG. 8. System 200 includes a regression model 201, which is a trained model corresponding to a manufacturing process such as manufacturing process 101 of FIG. 1, and can include a single step regression model such as any of regression models 106A-C or a global regression model such as global regression model 109 of FIG. 1 in various embodiments of the present invention. Regression model 201 receives raw data 202 which is received from sensors located in the manufacturing process. The raw data 202 can include any appropriate sensor data gathered during operation of the manufacturing process, including but not limited to temperature, level, flow rate, weight, actuator, and volume data. Regression model 201 performs performance monitoring 203 of the manufacturing process based on raw data 202, and monitored data 204 is determined based on performance monitoring 203. Raw data 202 and monitored data 204 are compared by internal analysis module 205 determines an observed difference between raw data 202 and monitored data 204. Internal analysis module 205 can determine a fidelity of the regression model 201 to the manufacturing process based on the observed difference; based on the observed difference being above a threshold, trained model 201 can be regenerated. Internal analysis module 205 can also determine an appropriate lookahead time horizon for decision support for the manufacturing process by regression model 201. Monitored data 204 is analyzed by external analysis module 206 determine a change in the model standard error α(t) over time; if the model standard error is observed to be increasing, deterioration of regression model 201 can be indicated and regeneration of regression model 201 can be performed. Internal analysis module is discussed in further detail below with respect to method 600 of FIG. 6, and external analysis module is discussed in further detail below with respect to method 700 of FIG. 7.

It is to be understood that the block diagram of FIG. 2 is not intended to indicate that the system 200 is to include all of the components shown in FIG. 2. Rather, the system 200 can include any appropriate fewer or additional components not illustrated in FIG. 2 (e.g., additional models, datasets, memory components, embedded controllers, functional blocks, connections between functional blocks, modules, inputs, outputs, etc.). Further, the embodiments described herein with respect to system 200 can be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

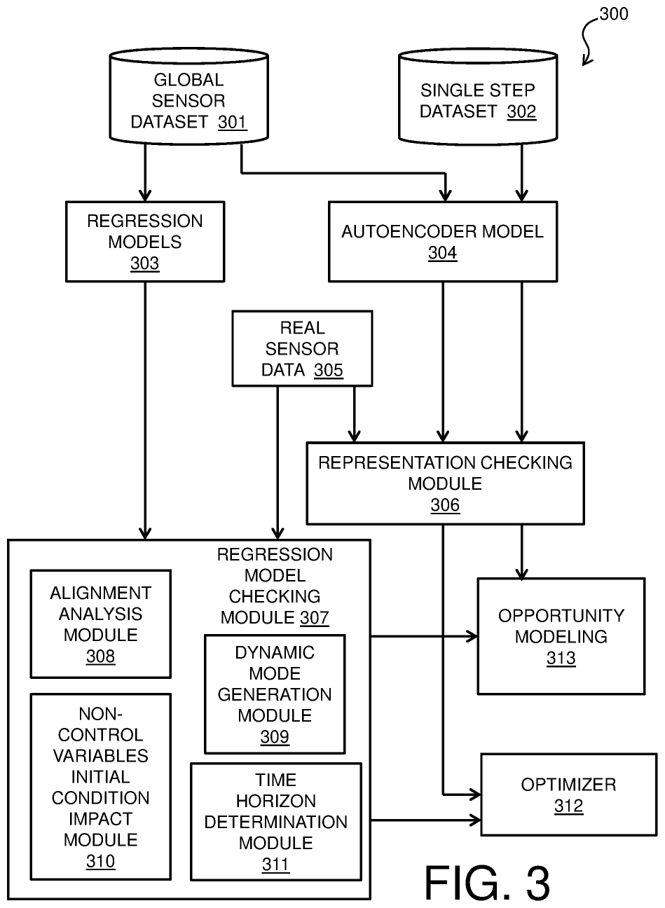

FIG. 3 shows a system 300 for model fidelity monitoring and regeneration for manufacturing process decision support in accordance with one or more embodiments of the present invention. Embodiments of system 300 can be implemented in conjunction with any appropriate computer system, such as computer system 800 of FIG. 8. System 300 receives sensor data from a manufacturing process, including a global sensor dataset 301 and a single step dataset 302. The historical sensor data included in global sensor dataset 301 and a single processing step dataset 302 can include any appropriate sensor data, including but not limited to temperature, level, flow rate, weight, actuator, and volume data. In various embodiments of the present invention, global sensor dataset 301 can correspond to sensor data from throughout a manufacturing process such as manufacturing process 101 of FIG. 1, and single step dataset 302 can correspond to sensor data from a single stage of a manufacturing process 101, such as any of stages 103A-C. Regression models 303, which are trained regression models corresponding to the manufacturing process, receive global sensor dataset 301, and determine expected outputs based on the global sensor dataset 301. The expected outputs are provided to regression model checking module 307. Regression model checking module 307 also receives real time sensor data 305 that is received from sensors located in the manufacturing process during operation, and compares the expected outputs from regression models 303 to the real time sensor data 305. Regression model checking module 307 includes alignment analysis module 308, dynamic mode generation module 309, non-control variables initial condition impact module 310, and time horizon determination module 311. Regression model checking module 307 can detect deterioration of regression models 303, and recommend regeneration of any of regression models 303 based on the detected deterioration.

Global sensor dataset 301 and single processing step dataset 302 are also provided to autoencoder model 304. Autoencoder model 304 determines an expected outcome based on each of global sensor dataset 301 and single processing step dataset 302, and provides the expected outcomes to representation checking module 306. Representation checking module 306 also receives real time sensor data 305. Representation checking module 306 compares the expected outcomes from the autoencoder model 304 to real time sensor data 305. If a difference between real time sensor data 305 and the expected outcome determined by the autoencoder model 304 based on global sensor dataset 301 is within an expected range, optimizer 312 can provide decision support for the manufacturing process based on regression models 303 for a lookahead time horizon that was determined by time horizon determination module 311. Opportunity modeling module 313 can determine whether any of regression models 303 need to be regenerated based on a difference between real time sensor data 305 and the expected outcome from the autoencoder model 304 that was determined based on single step dataset 302.

It is to be understood that the block diagram of FIG. 3 is not intended to indicate that the system 300 is to include all of the components shown in FIG. 3. Rather, the system 300 can include any appropriate fewer or additional components not illustrated in FIG. 3 (e.g., additional memory components, embedded controllers, functional blocks, connections between functional blocks, modules, inputs, outputs, models, datasets, etc.). Further, the embodiments described herein with respect to system 300 can be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

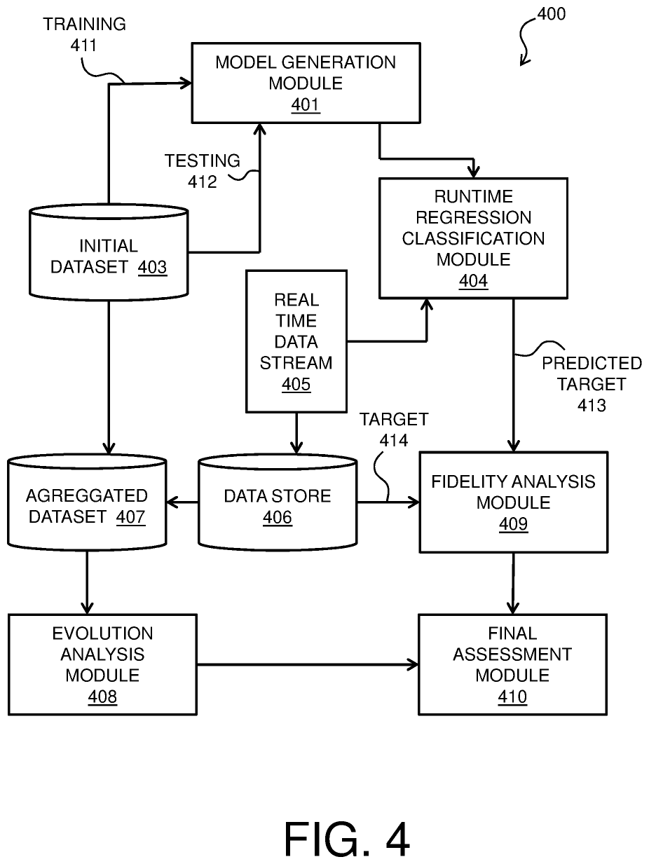

FIG. 4 shows a system 400 for regression model analysis for use in conjunction with model fidelity monitoring and regeneration for manufacturing process decision support in accordance with one or more embodiments of the present invention. Embodiments of system 400 can be implemented in conjunction with any appropriate computer system, such as computer system 800 of FIG. 8. System 400 includes a model generation module 401 that trains and tests a regression model of a manufacturing process based on training data 411 and testing data 412 from initial dataset 403. Initial dataset 403 can include any appropriate historical sensor data from a manufacturing process such as manufacturing process 101 of FIG. 1, including but not limited to temperature, level, flow rate, weight, actuator, and volume data. Embodiments of the trained model that is generated by model generation module 401 can include one or more single process step regression models, such as any of single process step models 106A-C of FIG. 1, and/or a global regression model, such as global model 109 of FIG. 1, and is output to runtime regression classification module 404. The runtime regression classification module 404 also receives a real time data stream 405 that includes real time sensor data received from the manufacturing process during operation. Runtime regression classification module 404 outputs predicted target 413 to fidelity analysis module 409. Real time data stream 405 is provided to data store 406, which outputs target 414 to fidelity analysis module 409. Fidelity analysis module 409 compares predicted target 413 and target 414, and outputs a result of the comparison to final assessment module 410.

Initial dataset 403 is provided to aggregated dataset 407, which also receives real time data stream 405 via data store 406. The aggregated dataset 407 is provided to evolution analysis module 408, which determines whether conditions in the manufacturing process have changed over time by comparison of initial dataset 403 and real time data stream 405. Evolution analysis module 408 can include one or more autoencoder models of the manufacturing process, such as autoencoder models 112 of FIG. 1; the initial dataset 403 can be input to the autoencoder models before comparison to real time data stream 405. The output of evolution analysis module 408 is provided to final assessment module 410. Final assessment module 410 can recommend generation of new models by model generation module 401 based on detection of model deterioration as indicated by the inputs from fidelity analysis module 409 and evolution analysis module 408.

It is to be understood that the block diagram of FIG. 4 is not intended to indicate that the system 400 is to include all of the components shown in FIG. 4. Rather, the system 400 can include any appropriate fewer or additional components not illustrated in FIG. 4 (e.g., additional memory components, embedded controllers, functional blocks, connections between functional blocks, modules, inputs, outputs, etc.). Further, the embodiments described herein with respect to system 400 can be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

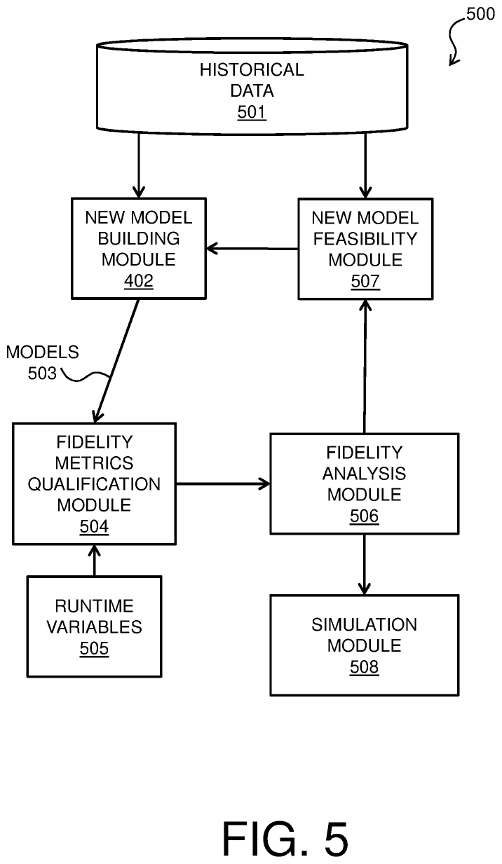

FIG. 5 shows a system 500 for model retraining for use in conjunction with model fidelity monitoring and regeneration for manufacturing process decision support in accordance with one or more embodiments of the present invention. Embodiments of system 500 can be implemented in conjunction with any appropriate computer system, such as computer system 800 of FIG. 8. Embodiments of system 500 can construct and train new regression models corresponding to a manufacturing process based on detection of deterioration in any existing regression models corresponding to the manufacturing process. System 500 receives historical data 501 corresponding to a manufacturing process, such as manufacturing process 101 of FIG. 1, and provides the historical data 501 to new model building module 502. New model building module 502 constructs regression models 503 (which can include global and/or single process step regression models such as model 109 and/or models 106A-C in various embodiments of the present invention) based on historical data 501, and provides models 503 to fidelity metrics qualification module 504. Fidelity metrics qualification module 504 checks the models 503 based on runtime variables 505, and outputs expected process outcomes to fidelity analysis module 506. Fidelity analysis module 506 determines whether the models 503 are trained based on any appropriate criteria. If the fidelity analysis module 506 determines that the models 503 are not trained, new model feasibility module 507 determines whether the models 503 are feasible. If the new model feasibility module 507 determines that the models 503 are not feasible, new model building module 502 can construct new models based on historical data 501. If the new model feasibility module 507 determines that the models 503 are feasible, the new model building module 502 continues to train models 503 based on historical data 501. The updated models 503 are output from new model building module 502 to fidelity metrics qualification module 504. Training of models 503 can repeat through any appropriate number of iterations in system 500. Based on the fidelity analysis module 506 determining that the models 503 are trained, simulation module 508 simulates and monitors the manufacturing process using trained models 503.

It is to be understood that the block diagram of FIG. 5 is not intended to indicate that the system 500 is to include all of the components shown in FIG. 5. Rather, the system 500 can include any appropriate fewer or additional components not illustrated in FIG. 5 (e.g., additional datasets, models, memory components, embedded controllers, functional blocks, connections between functional blocks, modules, inputs, outputs, etc.). Further, the embodiments described herein with respect to system 500 can be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

FIG. 6 shows a process flow diagram of a method 600 for model fidelity monitoring and regeneration for manufacturing process decision support for a global regression model in accordance with one or more embodiments of the present invention. Embodiments of method 600 can be implemented in conjunction with any appropriate computer system, such as computer system 800 of FIG. 8. Embodiments of method 600 of FIG. 6 can be implemented in any of internal analysis module 205 of FIG. 2, system 300 of FIG. 3, and/or system 400 of FIG. 4. In block 601 of method 600, for a regression model (such as global regression model 109 of FIG. 1) that is being used for monitoring and optimization of a manufacturing process such as manufacturing process 101 of FIG. 1, a historical sensor dataset including variables that were used to generate and train the regression model is determined. Embodiments of the historical sensor dataset of block 601 can include any appropriate sensor data gathered from the manufacturing process over a relatively long time period (e.g., years), and can correspond to any of global sensor dataset 301 of FIG. 3 or initial dataset 403 of FIG. 4. In block 602, a time series representation of the determined sensor dataset from block 601 is extracted, and autoencoder and neighborhood embedding of the extracted time series representation is determined.

In block 603, it is determined whether a current state of the manufacturing process that is given by the regression model is within a predefined range of the historical state of the manufacturing process based on the extracted time series representation from the historical sensor dataset. In some embodiments of block 603, a probability space (Ω, F, P), corresponding to the determined sensor dataset, and a probability space (Ω′, F′, P′), corresponding to the model output for a most recent time period (e.g., based on current real time sensor data from the manufacturing process), are compared. (Ω, F, P) and (Ω′, F′, P′) each represent respective probability spaces, including sample space, event space, and probability function, of the independent variables (x₁, x₂, . . . , xₙ₋₁, xₙ) in the determined sensor dataset versus in the current model output. Dimension reduction can be performed using t-distributed stochastic neighbor embedding (t-SNE) projection combined with autoencoding, which is a machine learning algorithm for visualization that provides nonlinear dimensionality reduction that can be used for embedding higher-dimensional data for visualization in a lower-dimensional space of two or three dimensions (e.g., (x₁, x₂, . . . , xₙ₋₁, xₙ)→(y₁, y₂)). Consecutive time periods having runtime scenarios located at the edge of the domain can indicate a need to regenerate the underlying regression model; for example, if the statistical distributions are changed significantly for a period of consecutive hours based on the difference between (Ω, F, P) and (Ω, F, P). Embodiments of blocks 602 and 603 can be implemented in alignment analysis module 308 of FIG. 3. If it is determined in block 603 that the current state of the manufacturing process that is given by the regression model is within the predefined range of the training dataset, the regression model can be determined to be relatively accurate, flow proceeds to block 604, and method 600 ends.

If it is determined in block 603 that the current state of the manufacturing process that is given by the regression model is not within the predefined range, flow proceeds from block 603 to block 605. In block 605, the accuracy of the regression model is detected based on sensor data from one or more time periods preceding the current time period. In block 605, an expected output from the regression model can be compared to an actual output of the manufacturing process based on sensor data from the manufacturing process for the one or more other time periods, and the determined difference can be compared to a predetermined threshold. In some embodiments of block 605, the regression model performance can be determined using a previous time period process dataset with a relatively short period temporal range. Observation and measurements, and assumptions of independent variables (x₁, x₂, . . . , xₙ₋₁, xₙ) of the regression model can be consistent for generating training input tuples, and generating runtime input tuples. Embodiments of the regression model may have been generated using sensor data from a relatively long time period (e.g., one to two years). The regression model that is used for optimization can be a relatively simple model, so as to ensure a relatively quick response time from the optimizer. However, such a relatively simple regression model may only capture the behaviors of relatively common operation scenarios in the manufacturing process. Over time, the sensor data corresponding to the independent variables (x₁, x₂, . . . , xₙ₋₁, xₙ)|ₜ can have a strong correlation due to consistent requirements of manufacturing process operation. The regression model can have systematic errors for certain mismatch operational scenarios due to a lack of representation of those scenarios in the regression model; identification of such operational scenarios can indicate a failure of the detection accuracy check of block 605.

In block 606, it is determined whether the detection accuracy determination of block 605 has detected a mismatch between the regression model and the manufacturing process based on identification of scenarios that are not represented in the regression model. If it is determined in block 606 that no mismatch was detected, flow proceeds from block 606 to block 607, the regression model is determined to be relatively accurate, and method 600 ends. In some embodiments of method 600, in block 606, if a mismatch is detected, a degree of the mismatch can be determined. If the degree of the mismatch is determined to be sufficiently large (e.g., greater than a decision support threshold) in block 606, it can be determined that the regression model has deteriorated to the point that decision support for the manufacturing process is not feasible using a data-driven regression model. Flow then proceeds from block 606 to block 607, and method 600 ends. In such embodiments of method 600, no decision support for the manufacturing process is performed due to the relatively large mismatch that was detected in block 606.

If it is determined in block 606 that a mismatch was detected, and the degree of the detected mismatch is relatively small (e.g., less than a decision support threshold), it is determined that the regression model has deteriorated, and flow proceeds from block 606 to block 608. In block 608, model regeneration is performed by generating a temporary dynamic regression model based on process data from a shortened time window (e.g., weeks, days, and hours before the current time). The temporary dynamic regression model can be generated in block 608 based on system 500 of FIG. 5 in some embodiments of the invention. The temporary dynamic regression model can be used to monitor and optimize the manufacturing process as a replacement for the deteriorated regression model during continuing operation of the manufacturing process. Embodiments of block 608 can be implemented in dynamic mode generation module 309 of FIG. 3.

In block 609, the impact of non-control variables on the reliability of the regression model is determined, and, in block 610, a lookahead time horizon for decision support using the temporary dynamic regression model is determined based on the impact of non-control variables that was determined in block 609. The temporary dynamic regression model can provide decision support for operation of the manufacturing process in the field for a time period corresponding to the time horizon that is determined in block 610. Selection of limited variables as control variables that are used to generate a regression model can impact the model fidelity. A subset of the independent variables may be used by the regression model as control variables; the non-control variables may use constant values in the decision process of over a lookahead time horizon to optimize production-related key performance indices. The selected constant values can correspond to the last measurements of the non-control variables from the manufacturing process before initiating of decision support for a lookahead time horizon of optimization. During operation of the manufacturing process, the constant historical values of the non-control variables used by the regression model can drift from the actual values present in the manufacturing process as time evolves. In some embodiments of blocks 609 and 610, t′ can be defined as a current time (e.g., hour), and an outcome-oriented validation of the model validation is defined based on t=t′—m being the indicator of the hour before the current hour. For a defined input tuple (x₁, x₂, . . . , xₙ₋₁, xₙ)ₜ of the observed independent variables, the tuple's corresponding true output yₜ from the manufacturing process, the tuple's predicted output \tilde{y}ₜ from the regression model and modified predicted output \tilde{y}ₜ₊₁′ are determined. For a positive integer 1≤1≤m, two deviation functions e(1) and r(1) can be constructed according to Equations (EQs.) 1 and 2:

e(1)=∥yₜ₊₁−\tilde{y}ₜ₊₁′∥ EQ. 1;

and

r(1)=∥yₜ₊₁−\tilde{y}ₜ₊₁′∥/∥yₜ₊₁∥ EQ. 2.

The value of \tilde{y}ₜ₊₁′ is computed choosing the function of \tilde{y}=f(x₁, x₂, . . . , xₙ₋₁, xₙ). The values of the control variables are determined according to EQ. 3, and according to EQ. 4 for non-control variables:

(x₁,x₂, . . . ,xₖ) [symbol] (x₁,x₂, . . . ,xₖ)ₜ₊₁ EQ. 3;

and

(xₖ₊₁, . . . ,xₙ₋₁,xₙ) [symbol] (xₖ₊₁, . . . ,xₙ₋₁,xₙ)ₜ EQ. 4.

In embodiments of block 610, the error distribution change for a different hour (indexed as a positive integer 1≤1≤m) can be determined to identify the performance decay over a different hour within the time horizon, and the time horizon for use of the temporary dynamic regression model can be determined in block 610 based on the performance decay. Embodiments of block 609 can be implemented in non-control variables initial condition impact module 310 of FIG. 3, and embodiments of block 610 can be implemented in time horizon determination module 311 of FIG. 3.

Method 600 can be repeated at any appropriate interval throughout operation of embodiments of a manufacturing process modeling system (e.g., system 100 of FIG. 1) in order to ensure fidelity of a regression model that is being used to monitor and optimize a manufacturing process such as manufacturing process 101 of FIG. 1. A detected loss of fidelity according to method 600 can indicate that regeneration of the regression model is required.

The process flow diagram of FIG. 6 is not intended to indicate that the operations of the method 600 are to be executed in any particular order, or that all of the operations of the method 600 are to be included in every case. Additionally, the method 600 can include any suitable number of additional operations.

FIG. 7 shows a process flow diagram of a method 700 for model fidelity monitoring and regeneration for manufacturing process decision support for a process step regression model in accordance with one or more embodiments of the present invention. Embodiments of method 700 can be implemented in conjunction with any appropriate computer system, such as computer system 700 of FIG. 8. Embodiments of method 700 of FIG. 7 can be implemented in any of external analysis module 206 of FIG. 2, system 300 of FIG. 3, and/or system 400 of FIG. 4. In block 701 of method 700, for process step regression models (such as any of regression models 106A-C of FIG. 1) that are being used for monitoring and optimization of one or more stages of a manufacturing process (such as stages 103A-C of manufacturing process 101 of FIG. 1), a historical sensor dataset including variables that were used to generate the regression models is determined, a time series representation of the determined sensor dataset is extracted, and autoencoder and neighborhood embedding of the extracted time series representation is determined. Embodiments of the historical sensor dataset of block 701 can include any appropriate sensor data gathered from the manufacturing process, and can correspond to any of single step dataset 302 of FIG. 3 or initial dataset 403 of FIG. 4.

In block 702, a neighborhood of the current state of the manufacturing process that is given by the regression models is identified based on the extracted time series data of block 701. In block 702, the neighborhood can be identified by determining whether a current state of the manufacturing process as given by the regression models is located in a proper range for optimization using the regression model. The current operational state of as represented by embedding should not be an outlier in the embedded space based on all available sensor data. If the current state is determined to be an outlier, the regression models corresponding to the manufacturing process may not be reliable. In some embodiments of block 702, dimension reduction of the extracted time series data is performed using t-SNE. Neighborhood size analysis is performed by checking the size of a neighborhood to find out a similar scenario in the historical data based on the reduced time series data. A center (y₁, y₂)₀ can be defined as the center of the independent variable domain, i.e. the average of (y₁, y₂) of the mapped domain. An average distance of values of (y₁, y₂) from the center can be defined as r₀. It can be determined whether an embedding of the current operational state is located at a central region of the domain. A single instance of a runtime state located at the edge of the domain indicates a risk of applying the regression model to this state. If it is assumed that the map of an input is (y₁, y₂), the distance ratio

$$\frac{‖ ( {y}_{1} , {y}_{2} ) - {( {y}_{1} , {y}_{2} )}_{0} ‖}{{r}_{0}}$$

can be defined as the criteria to determine whether the current state is covered by the model in block 702, and the neighborhood is identified based on the current state being determined to be covered by the regression models.

In block 703, it is determined whether the neighborhood of the current state was successfully identified in block 702. If it is determined that the neighborhood was not identified in block 702, flow proceeds to block 704, in which it is determined that the regression models have deteriorated. Opportunity modeling of the manufacturing process using the regression models is stopped in block 704, regeneration of the models is recommended (e.g., according to system 500 of FIG. 5), and method 700 ends. If it is determined in block 703 that the neighborhood of the current state was identified, flow proceeds from block 703 to block 705. In block 705, opportunity modeling of the manufacturing process is performed using the regression models based on the identified neighborhood. Method 700 can be repeated at any appropriate interval throughout operation of embodiments of a manufacturing process modeling system (e.g., system 100 of FIG. 1) in order to ensure fidelity of any regression models that are being used to monitor and optimize a manufacturing process such as manufacturing process 101 of FIG. 1.

The process flow diagram of FIG. 7 is not intended to indicate that the operations of the method 700 are to be executed in any particular order, or that all of the operations of the method 700 are to be included in every case. Additionally, the method 700 can include any suitable number of additional operations.

Turning now to FIG. 8, a computer system 800 is generally shown in accordance with an embodiment. The computer system 800 can be an electronic, computer framework comprising and/or employing any number and combination of computing devices and networks utilizing various communication technologies, as described herein. The computer system 800 can be easily scalable, extensible, and modular, with the ability to change to different services or reconfigure some features independently of others. The computer system 800 can be, for example, a server, desktop computer, laptop computer, tablet computer, or smartphone. In some examples, computer system 800 can be a cloud computing node. Computer system 800 can be described in the general context of computer system executable instructions, such as program modules, being executed by a computer system. Generally, program modules can include routines, programs, objects, components, logic, data structures, and so on that perform particular tasks or implement particular abstract data types. Computer system 800 can be practiced in distributed cloud computing environments where tasks are performed by remote processing devices that are linked through a communications network. In a distributed cloud computing environment, program modules can be located in both local and remote computer system storage media including memory storage devices.

As shown in FIG. 8, the computer system 800 has one or more central processing units (CPU(s)) 801a, 801b, 801c, etc. (collectively or generically referred to as processor(s) 801). The processors 801 can be a single-core processor, multi-core processor, computing cluster, or any number of other configurations. The processors 801, also referred to as processing circuits, are coupled via a system bus 802 to a system memory 803 and various other components. The system memory 803 can include a read only memory (ROM) 804 and a random access memory (RAM) 805. The ROM 804 is coupled to the system bus 802 and can include a basic input/output system (BIOS), which controls certain basic functions of the computer system 800. The RAM is read-write memory coupled to the system bus 802 for use by the processors 801. The system memory 803 provides temporary memory space for operations of said instructions during operation. The system memory 803 can include random access memory (RAM), read only memory, flash memory, or any other suitable memory systems.

The computer system 800 comprises an input/output (I/O) adapter 806 and a communications adapter 807 coupled to the system bus 802. The I/O adapter 806 can be a small computer system interface (SCSI) adapter that communicates with a hard disk 808 and/or any other similar component. The I/O adapter 806 and the hard disk 808 are collectively referred to herein as a mass storage 810.

Software 811 for execution on the computer system 800 can be stored in the mass storage 810. The mass storage 810 is an example of a tangible storage medium readable by the processors 801, where the software 811 is stored as instructions for execution by the processors 801 to cause the computer system 800 to operate, such as is described herein below with respect to the various Figures. Examples of computer program product and the execution of such instruction is discussed herein in more detail. The communications adapter 807 interconnects the system bus 802 with a network 812, which can be an outside network, enabling the computer system 800 to communicate with other such systems. In one embodiment, a portion of the system memory 803 and the mass storage 810 collectively store an operating system, which can be any appropriate operating system, such as the z/OS or AIX operating system from IBM Corporation, to coordinate the functions of the various components shown in FIG. 8.

Additional input/output devices are shown as connected to the system bus 802 via a display adapter 815 and an interface adapter 816 and. In one embodiment, the adapters 806, 807, 815, and 816 can be connected to one or more I/O buses that are connected to the system bus 802 via an intermediate bus bridge (not shown). A display 819 (e.g., a screen or a display monitor) is connected to the system bus 802 by a display adapter 815, which can include a graphics controller to improve the performance of graphics intensive applications and a video controller. A keyboard 821, a mouse 822, a speaker 823, etc. can be interconnected to the system bus 802 via the interface adapter 816, which can include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI). Thus, as configured in FIG. 8, the computer system 800 includes processing capability in the form of the processors 801, and, storage capability including the system memory 803 and the mass storage 810, input means such as the keyboard 821 and the mouse 822, and output capability including the speaker 823 and the display 819.

In some embodiments, the communications adapter 807 can transmit data using any suitable interface or protocol, such as the internet small computer system interface, among others. The network 812 can be a cellular network, a radio network, a wide area network (WAN), a local area network (LAN), or the Internet, among others. An external computing device can connect to the computer system 800 through the network 812. In some examples, an external computing device can be an external webserver or a cloud computing node.

It is to be understood that the block diagram of FIG. 8 is not intended to indicate that the computer system 800 is to include all of the components shown in FIG. 8. Rather, the computer system 800 can include any appropriate fewer or additional components not illustrated in FIG. 8 (e.g., additional memory components, embedded controllers, modules, additional network interfaces, etc.). Further, the embodiments described herein with respect to computer system 800 can be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted, or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
determining, by a processor, that an output of a regression model corresponding to a current time period of decision support for a manufacturing process is not within a predefined range of a historical process dataset from the manufacturing process, wherein the regression model was constructed based on the historical process dataset;
based on determining that the output of the regression model corresponding to the current time period of decision support for the manufacturing process is not within the predefined range of the historical process dataset, performing an accuracy and fidelity analysis on the regression model based on process data from the manufacturing process corresponding to a previous time period;
based on a result of the accuracy and fidelity analysis being below a threshold, determining a mismatch of the regression model as compared to the manufacturing process;
based on determining the mismatch, generating a temporary regression model corresponding to the manufacturing process; and
performing decision support for the manufacturing process based on the temporary regression model.

2. The method of claim 1, wherein determining that the output of the regression model corresponding to the current time period is not within the predefined range of the historical process dataset comprises:
extracting time series data corresponding to independent variables in the historical process dataset;
determining a first probability space corresponding to the independent variables in the current time period;
determining a second probability space corresponding to the independent variables in the extracted time series data; and
comparing the first probability space and the second probability space.

3. The computer-implemented of claim 1, further comprising:
determining a degree of the mismatch; and
based on the degree of the mismatch being above a decision support threshold, stopping decision support for the manufacturing process based on the regression model, wherein the temporary regression model is generated based on the degree of the mismatch being below the decision support threshold.

4. The computer-implemented of claim 1, wherein generating the temporary regression model comprises:
generating the temporary regression model based on process data from a first time period, wherein the first time period is shorter than a second time period corresponding to the historical process dataset that was used to construct the regression model.

5. The computer-implemented of claim 1 further comprising:
determining a set of control variables and non-control variables that were used to generate the temporary regression model;
determining a time horizon based on the determined set of non-control variables; and
performing decision support for the manufacturing process based on the temporary regression model for the determined time horizon.

6. The computer-implemented of claim 1, wherein:
the regression model comprises a global regression model; and
the computer-implemented method further comprises:
identifying a neighborhood of a current output of a process step regression model, the process step regression model corresponding to a single stage of the manufacturing process;
based on identifying the neighborhood, performing opportunity modeling of the single stage of the manufacturing process based on the process step regression model; and
based on being unable to identify the neighborhood, regenerating the process step regression model.

7. The computer-implemented of claim 6, wherein identifying the neighborhood comprises:
determining a center of an independent variable domain of historical process data corresponding to the single stage; and
determining a distance of the current output of the process step regression model from the determined center.

8. A system comprising:
a memory having computer readable instructions; and
one or more processors for executing the computer readable instructions, the computer readable instructions controlling the one or more processors to perform operations comprising:
determining that an output of a regression model corresponding to a current time period of decision support for a manufacturing process is not within a predefined range of a historical process dataset from the manufacturing process, wherein the regression model was constructed based on the historical process dataset;
based on determining that the output of the regression model corresponding to the current time period of decision support for the manufacturing process is not within the predefined range of the historical process dataset, performing an accuracy and fidelity analysis on the regression model based on process data from the manufacturing process corresponding to a previous time period;
based on a result of the accuracy and fidelity analysis being below a threshold, determining a mismatch of the regression model as compared to the manufacturing process;
based on determining the mismatch, generating a temporary regression model corresponding to the manufacturing process; and
performing decision support for the manufacturing process based on the temporary regression model.

9. The system of claim 8, wherein determining that the output of the regression model corresponding to the current time period is not within the predefined range of the historical process dataset comprises:
extracting time series data corresponding to independent variables in the historical process dataset;
determining a first probability space corresponding to the independent variables in the current time period;
determining a second probability space corresponding to the independent variables in the extracted time series data; and
comparing the first probability space and the second probability space.

10. The system of claim 8, further comprising:
determining a degree of the mismatch; and
based on the degree of the mismatch being above a decision support threshold, stopping decision support for the manufacturing process based on the regression model, wherein the temporary regression model is generated based on the degree of the mismatch being below the decision support threshold.

11. The system of claim 8, wherein generating the temporary regression model comprises:
generating the temporary regression model based on process data from a first time period, wherein the first time period is shorter than a second time period corresponding to the historical process dataset that was used to construct the regression model.

12. The system of claim 8 further comprising:
determining a set of control variables and non-control variables that were used to generate the temporary regression model;
determining a time horizon based on the determined set of non-control variables; and
performing decision support for the manufacturing process based on the temporary regression model for the determined time horizon.

13. The system of claim 8, wherein:
the regression model comprises a global regression model; and
the computer-implemented method further comprises:
identifying a neighborhood of a current output of a process step regression model, the process step regression model corresponding to a single stage of the manufacturing process;
based on identifying the neighborhood, performing opportunity modeling of the single stage of the manufacturing process based on the process step regression model; and
based on being unable to identify the neighborhood, regenerating the process step regression model.

14. The system of claim 13, wherein identifying the neighborhood comprises:
determining a center of an independent variable domain of historical process data corresponding to the single stage; and
determining a distance of the current output of the process step regression model from the determined center.

15. A computer program product comprising a computer readable storage medium having program instructions embodied therewith, the program instructions executable by one or more processors to cause the one or more processors to perform operations comprising:
determining that an output of a regression model corresponding to a current time period of decision support for a manufacturing process is not within a predefined range of a historical process dataset from the manufacturing process, wherein the regression model was constructed based on the historical process dataset;
based on determining that the output of the regression model corresponding to the current time period of decision support for the manufacturing process is not within the predefined range of the historical process dataset, performing an accuracy and fidelity analysis on the regression model based on process data from the manufacturing process corresponding to a previous time period;
based on a result of the accuracy and fidelity analysis being below a threshold, determining a mismatch of the regression model as compared to the manufacturing process;
based on determining the mismatch, generating a temporary regression model corresponding to the manufacturing process; and
performing decision support for the manufacturing process based on the temporary regression model.

16. The computer program product of claim 15, wherein determining that the output of the regression model corresponding to the current time period is not within the predefined range of the historical process dataset comprises:
extracting time series data corresponding to independent variables in the historical process dataset;
determining a first probability space corresponding to the independent variables in the current time period;
determining a second probability space corresponding to the independent variables in the extracted time series data; and
comparing the first probability space and the second probability space.

17. The computer program product of claim 15, further comprising
determining a degree of the mismatch; and
based on the degree of the mismatch being above a decision support threshold, stopping decision support for the manufacturing process based on the regression model, wherein the temporary regression model is generated based on the degree of the mismatch being below the decision support threshold.

18. The computer program product of claim 15, wherein generating the temporary regression model comprises:
generating the temporary regression model based on process data from a first time period, wherein the first time period is shorter than a second time period corresponding to the historical process dataset that was used to construct the regression model.

19. The computer program product of claim 15 further comprising:
determining a set of control variables and non-control variables that were used to generate the temporary regression model;
determining a time horizon based on the determined set of non-control variables; and
performing decision support for the manufacturing process based on the temporary regression model for the determined time horizon.

20. The computer program product of claim 15, wherein:
the regression model comprises a global regression model; and
the computer-implemented method further comprises:
identifying a neighborhood of a current output of a process step regression model, the process step regression model corresponding to a single stage of the manufacturing process;
based on identifying the neighborhood, performing opportunity modeling of the single stage of the manufacturing process based on the process step regression model; and
based on being unable to identify the neighborhood, regenerating the process step regression model.

21. The computer program product of claim 20, wherein identifying the neighborhood comprises:
determining a center of an independent variable domain of historical process data corresponding to the single stage; and
determining a distance of the current output of the process step regression model from the determined center.

22. A computer-implemented method comprising:
identifying, by a processor, a neighborhood of a current output of a process step regression model, the process step regression model corresponding to a single stage of a manufacturing process;
based on identifying the neighborhood, performing opportunity modeling of the single stage of the manufacturing process based on the process step regression model; and
based on being unable to identify the neighborhood, regenerating the process step regression model.

23. The computer-implemented method of claim 22, wherein identifying the neighborhood comprises:
determining a center of an independent variable domain of historical process data corresponding to the single stage; and
determining a distance of the current output of the process step regression model from the determined center.

24. A system comprising:
a memory having computer readable instructions; and
one or more processors for executing the computer readable instructions, the computer readable instructions controlling the one or more processors to perform operations comprising:
identifying a neighborhood of a current output of a process step regression model, the process step regression model corresponding to a single stage of a manufacturing process;
based on identifying the neighborhood, performing opportunity modeling of the single stage of the manufacturing process based on the process step regression model; and
based on being unable to identify the neighborhood, regenerating the process step regression model.

25. The system of claim 24, wherein identifying the neighborhood comprises:
determining a center of an independent variable domain of historical process data corresponding to the single stage; and
determining a distance of the current output of the process step regression model from the determined center.
